(19) United States
(12) Patent Application Publication
(10) Pub. No.: US 2015/0336041 A1
(43) Pub. Date: Nov. 26, 2015

(54) Segmented Filter Assembly

(71) Applicants: Martin Gregory Hatfield, Odessa, MO (US); Ryan Margate Pastrana, Kansas City, MO (US)

(72) Inventors: Martin Gregory Hatfield, Odessa, MO (US); Ryan Margate Pastrana, Kansas City, MO (US)

(73) Assignee: BHA ALTAIR, LLC, Franklin, TN (US)

(21) Appl. No.: 14/284,032

(22) Filed: May 21, 2014

(51) Int. Cl. B01D 46/00; B01D 46/02

(52) U.S. Cl. CPC B01D 46/008; B01D 46/0023; B01D 46/0005; B01D 46/023

(57) ABSTRACT

A filter assembly for mounting to an opening in a tube sheet of a filter system is provided. The filter assembly includes a plurality of filter elements and a mounting structure. Each filter element includes an extension of filter media, a first coupling portion, and a second coupling portion. The first and second coupling portions are attached to the filter media. The first and second coupling portions are connectable to one another to secure a first one of the plurality of filter elements to a second one of the plurality of filter elements such that fluid communication between the first and second filter elements is established when connected. The mounting structure is sized and configured to mount to the tube sheet adjacent the opening. The mounting structure includes a mounting structure coupling portion being connectable to the first coupling portions of the filter elements.

### FIELD OF THE INVENTION

The present invention relates generally to a filter assembly for use in a filter system. In particular, the present invention relates to a multi-piece filter assembly for use in a filter system.

### BACKGROUND OF THE INVENTION

There is a desire to capture air born particulates for generating powder products or to reduce air-borne pollutants and emissions from certain industrial sources, such as power plants and materials production facilities throughout the world. A known technique to control and capture the particulates or emissions from the industrial sources is to separate the particulate matter that is carried in a gas stream by using filtration media. Historically, the filtration media was a fabric and the fabric filtration was accomplished in a filter system in the form of a dust collection apparatus known in the industry as a “baghouse.”

The baghouse typically includes a housing divided into two plenums by a tube sheet. One plenum is a “dirty air” plenum which communicates with an inlet and receives “dirty” or particulate laden gas from a source at the plant. The other plenum is a “clean air” plenum which receives cleaned gas after filtration and communicates with an outlet to direct cleaned gas away from the baghouse. A plurality of relatively long cylindrical fabric filters, commonly called “bags,” were suspended from the tube sheet in the dirty air plenum. Each bag had a closed lower end and is installed over a cage. Each bag was mounted to the tube sheet at its upper end and hung vertically downward into the dirty air plenum. The upper end portion of the bag was open and the interior of each bag is in fluid communication with the clean air plenum. However, air flow in the opposite direction is also possible.

There has been an interest in replacing known fabric filter bags with media filter cartridges (also referred to as elements) other than the fabric bags. One such media filter cartridge utilizes pleated media to increase the effective filtering area while occupying the same, or less, space within the baghouse.

One problem with baghouses is that the opening that connects the clean air plenum and dirty air plenum can often vary from one baghouse to the next. Due to this, it can be difficult to maintain a large number of baghouses because there may be a need for a large number of different mounting interfaces for the various different openings. A second problem is that different bag houses have different dirty air plenum volumes and dimensions such that various baghouses may have different sized filter cartridges. Again, this can require a large number of different filter elements to be maintained on hand which provides logistical difficulties.

Embodiments of the invention provide improvements over the art as it relates to replaceable filter elements or cartridges for baghouse filtration systems.

### BRIEF SUMMARY OF THE INVENTION

Embodiments of the invention provide improvements over the art that reduce the number of different filter elements that need be maintained on hand for replacement of filter cartridges or bags for use with filter systems, and particularly bag house filter systems. Embodiments of the invention allow for on hand filter elements to be onsite customized to mount to a tube sheet or for filter elements to be customized by a supplier at the time of order by a customer.

In one embodiment, a filter assembly is provided. The filter assembly is to be used within a filter system for removing particulates or impurities entrained within a gas stream. The filter system has a plurality of plenums separated by a tube sheet. The tube sheet defines an opening through which the gas stream can travel between the plenums.

The filter assembly includes a plurality of filter elements and a mounting structure. Each filter element includes an extension of filter media, a first coupling portion, and a second coupling portion. The first and second coupling portions are attached to the filter media. The first and second coupling portions are connectable to one another to secure a first one of the plurality of filter elements to a second one of the plurality of filter elements such that fluid communication between the first and second filter elements is established when connected. The mounting structure is sized and configured to mount to the tube sheet adjacent the opening. The mounting structure includes a mounting structure coupling portion being connectable to the first coupling portions of the filter elements. By utilizing a mounting structure that is connected able to the filter media, the filter assembly can be customized easily on site or at the time of ordering.

In one embodiment, an end cap structure having an end cap structure coupling portion being connectable to the second coupling portions is provided. The end cap structure is used to close an open end of the filter assembly. In one embodiment, the mounting structure and/or the end cap structure are removable and reusable.

In one embodiment, the extension of filter media of each filter element is an annular tube of filter media defining an internal cavity. The internal cavities of connected filter elements are in fluid communication when assembled.

In one embodiment, the extension of filter media of each filter element extends axially between first and second ends. The first coupling portion is attached to the filter media proximate the first end and the second coupling portion is attached proximate the filter media proximate the second end.

In one embodiment, the extension of filter media of each filter element extends axially between first and second ends. The first coupling portion is, at least, part of a first end cap attached to the filter media proximate the first end. The second coupling portion is, at least, part of a second end cap attached to the filter media proximate the second end.

In one embodiment, the first end cap is an assembly of a plurality of components interconnected together and the second end cap is an assembly of a plurality of components interconnected together.

In one embodiment, the first end cap is a one piece construction including the first coupling portion and the second end cap is a one piece construction including the second coupling portion. A one piece construction as used herein is not an assembly of a plurality of components interconnected but is instead formed from a continuous piece of material, such as, e.g., by way of molding.

In one embodiment, the extension of filter media of each filter element extends axially between first and second ends. Each filter element includes a first end cap attached to the filter media proximate the first end and a second end cap attached to the filter media proximate the second end.

In one embodiment, at least one of the filter elements includes a center tube and at least one of the first and second coupling portions of that filter element are attached to the centertube. The coupling portions may be attached to the centertube by the components being formed all as a single continuous piece or as separate components attached together.

In one embodiment, at least one sealing gasket is interposed between each interconnected first and second coupling portions.

In one embodiment, a filter replacement kit for replacing a spent filter element within a filter system is provided. The filter system has a plurality of plenums separated by a tube sheet. The tube sheet defines an opening through which the gas stream can travel between the plenums. The filter replacement kit includes a plurality of filter elements, a first mounting structure and a second mounting structure. Each filter element includes an extension of filter media, a first coupling portion and a second coupling portion. The first coupling portion is attached to the filter media. The second coupling portion is attached to the filter media. The first and second coupling portions are connectable to one another to secure a first one of the plurality of filter elements to a second one of the plurality of filter elements such that fluid communication between the first and second filter elements is established when connected. The first mounting structure includes a first mounting structure coupling portion being connectable to the first coupling portions. The first mounting structure includes a first tube sheet interface structure having a first configuration configured to mount the first mounting structure to an opening of a tube sheet. The second mounting structure includes a second mounting structure coupling portion being connectable to the first coupling portions. The second mounting structure includes a tube sheet interface structure having a second configuration configured to mount the first mounting structure to an opening of a tube sheet. The second configuration is different than the first configuration.

In one embodiment, the first configuration has a same shape as the second configuration. The first configuration has a different size than the second configuration.

In one embodiment, the first configuration has a different shape than the second configuration.

In one embodiment, the first tube sheet interface structure includes a first sealing surface defining at least in part the first configuration and the second tube sheet interface includes a second sealing surface defining at least in part the second configuration. In one embodiment, the sealing surfaces are provided by gaskets. In another embodiment, the sealing surfaces are provided by wall portions of the mounting structures.

In another embodiment, a method of replacing a spent filter within a filter system is provided. The filter system has a plurality of plenums separated by a tube sheet. The tube sheet defines an opening through which the gas stream can travel between the plenums.

The method includes removing a first filter from the tube sheet, the first filter having an extension of filter media and a permanent mounting structure attached to the filter media. The method includes mounting a filter assembly to the tube sheet. The filter assembly includes a plurality of filter elements. Each filter element includes an extension of filter media, a first coupling portion and a second coupling portion. The first coupling portion is attached to the filter media. The second coupling portion is attached to the filter media. The first and second coupling portions being connectable to one another to secure a first one of the plurality of filter elements to a second one of the plurality of filter elements such that fluid communication between the first and second filter elements is established when connected. The filter assembly includes a connectable mounting structure sized and configured to mount to the tube sheet adjacent the opening. The connectable mounting structure includes a mounting structure coupling portion being connectable to the first coupling portions.

In one embodiment, the permanent mounting structure includes a first tube sheet interface structure having a first configuration configured to mount the first mounting structure to the opening of the tube sheet. The connectable mounting structure includes a second tube sheet interface structure having a second configuration configured to mount the second mounting structure to the opening of the tube sheet. The first and second interfaces are the same.

In one embodiment, the mounting structure coupling portion releasably and reusably connects to the first coupling portions.

In one embodiment, the method includes disconnecting the mounting structure coupling portion from a first coupling portion of a spent filter element and connecting the mounting structure coupling portion to a first coupling portion of a replacement filter element.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic illustration of the interior of a baghouse filter system in which a plurality of filter assemblies are top loaded for at least partially removing particulate matter entrained within a gaseous stream;

FIG. 2 is an elevation view of one of the filter assemblies of FIG. 1;

FIG. 3 is an exploded elevation view of the filter assembly of FIG. 2;

FIG. 4 is a cross-sectional elevation view of the filter assembly of FIG. 2;

FIG. 5 is a cross-sectional exploded view of FIG. 4;

FIG. 6 is an elevation view of an alternative embodiment of a filter assembly for use in the baghouse of FIG. 1;

FIG. 7 is a cross-sectional exploded view of FIG. 6;

FIG. 8 is a flowchart illustrating steps of replacing a filter element according to an embodiment of the invention; and

FIG. 9 is a cross-sectional elevation view of an alternative embodiment of a filter assembly for use in the filter system of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

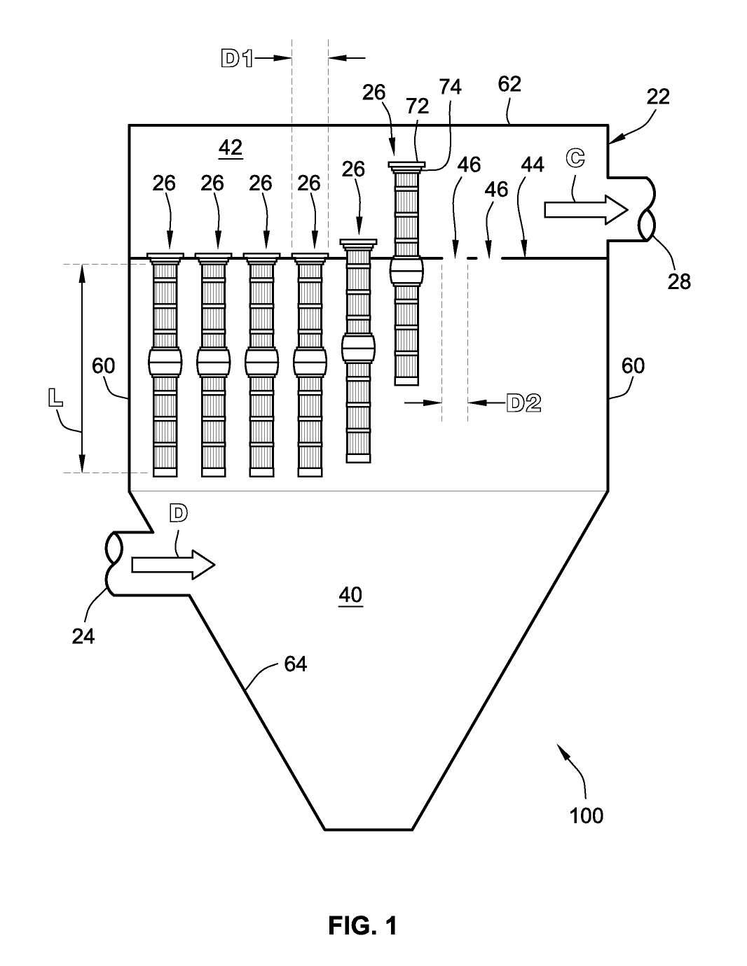

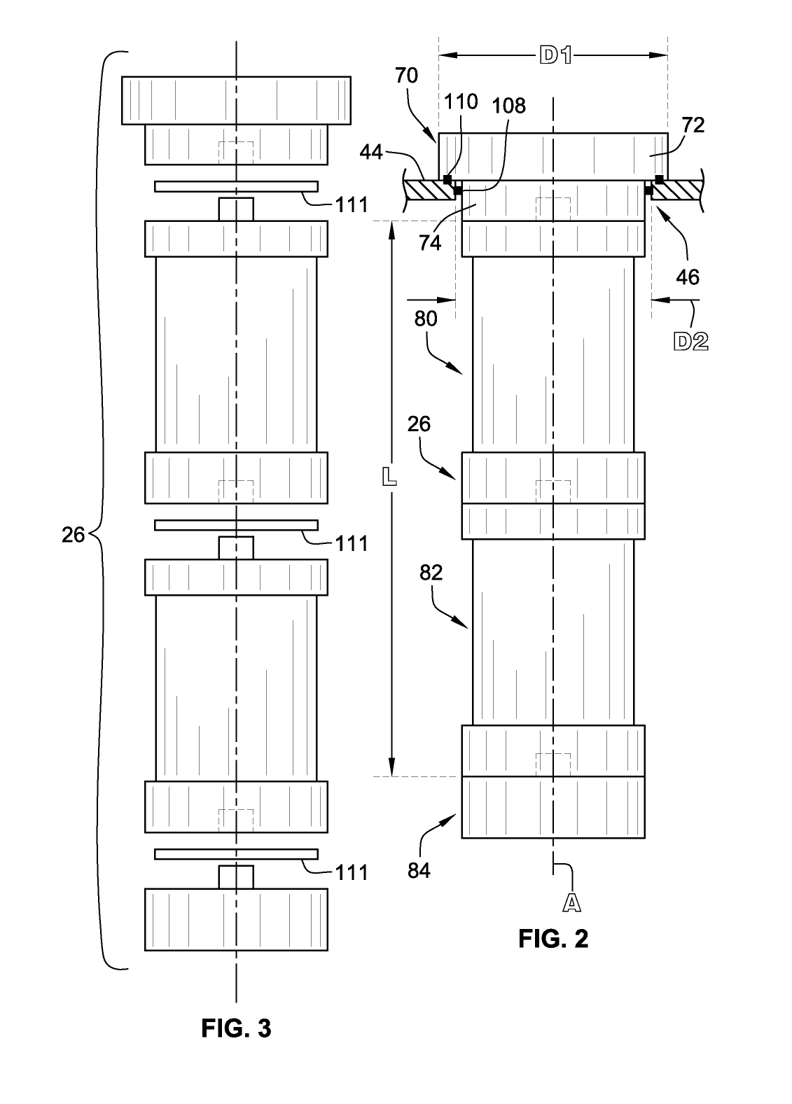

A filter system in the form of a baghouse 20 is illustrated in FIG. 1. The baghouse 20 is defined by an enclosed housing 22. The housing 22 is made from a suitable material, such as sheet metal. Particulate laden gas D flows into the baghouse 20 from an inlet 24. The particulate laden gas D is filtered by a plurality of relatively long cartridges or filter assemblies 26 (best seen in FIG. 2) constructed according to one aspect of the invention located within the baghouse 20. Cleaned gas C exits through an outlet 28 of the baghouse 20.

The baghouse 20 is divided into a “dirty air” plenum 40 and a “clean air” plenum 42 by a tube sheet 44 made from a suitable material, such as sheet metal. The tube sheet 44 has at least a portion that is substantially planar. The inlet 24 is in fluid communication with the dirty air plenum 40. The outlet 28 is in fluid communication with the clean air plenum 42.

A plurality of openings 46 extend through the planar portion of the tube sheet 44. A filter assembly 26 is installed in a respective opening 46, and can optionally extend at least partially through the respective opening 46. The filter assembly 26 can be suspended by the tube sheet 44 itself, or any other suitable support adjacent to the openings 46 in which the filter assembly 26 is to be installed. The clean air plenum 42 has a minimum dimension or clearance height taken in a direction normal to the tube sheet 44 that defines an access space. The dirty air plenum 40 has a height taken in a direction normal to the tube sheet 44 in which a filter assembly 26 can be installed without engaging the housing 22 of the baghouse 20. The height of the dirty air plenum 40 is typically greater than the height of the clean air plenum 42.

The housing 22 of the baghouse 20 includes sides 60 and a roof 62. The baghouse 20 is illustrated as having a non-movable roof 62. Thus, access to the clean air plenum 42 and baghouse 20 is limited for installation of the filter assemblies 26. It will be apparent to one skilled in the art that the roof 62 can have access panels that are removable or movable to a position that does not inhibit access to the clean air plenum 42.

The baghouse 20 also has an accumulation chamber defined by sloped walls 64 located at a lower end of the dirty air plenum 40. The filter assemblies 26 are illustrated as not extending into the accumulation chamber but it will be apparent that the filter assemblies may extend into the accumulation chamber.

A circumferentially directed seal 65, an axially directed seal 65 or both a radially directed seal 65 and axially directed seal 66 can be provided to provide a seal between the filter assembly 26 and the opening 46 in the tube sheet 44 to minimize the passage of gas from the dirty air plenum 40 into the clean air plenum 42 between the filter assembly 26 and the tube sheet 44. Other sealing arrangements that may be used to seal the filter assembly 26 to the tube sheet 44 are illustrated in U.S. Pat. Nos. 7,927,392 and 5,746,792 assigned to the assignee of the instant application. The teachings and disclosures of which are incorporated herein in their entireties by reference thereto.

The filter assemblies 26 filter particulates from the particulate laden gas D as the gas D passes through each filter assembly 26. Each filter assembly 26 is made up of a mounting structure 70, at least a first or upper filter element 80 (as viewed in FIG. 2), a second or lower filter element 82 and a universal end cap structure 84. The mounting structure 70, filter elements 80, 82 and universal end cap structure 84 are axially aligned in an end-to-end stack and connected together in a fluid tight relationship.

In the illustrated embodiment, each filter assembly 26 is supported at its upper end (as viewed in FIGS. 1 and 2) by the tube sheet 44 and hangs downwardly in a substantially vertical direction. The mounting structure 70 is located at the upper end (as viewed in FIG. 2) of the filter assembly 26 and bears the entire weight of the filter assembly 26 when mounted to the tube sheet 44. The mounting structure 70 has a stepped or T-shape that includes a head portion 72 that has an outer dimension D1 that is greater than the inner dimension D2 of openings 46. The mounting structure 70 further includes a neck portion 74 that has an outer dimension that is substantially equal to or corresponds to the inner dimension D2 of the openings 46. The mounting structure 70 is formed from any suitable material such as molded plastic or stamped or molded metal as is necessary for the particular installation. While being mounted in this orientation, other embodiments could have the filter elements installed from the bottom, rather than the top of the tube sheet 44.

While the peripheral shape of the mounting structure 70 is typically the same as or similar to the shape of the opening 46 through tube sheet 44, some embodiments may have the shapes different. For example, in some embodiments, the mounting structure 70 may have a rectangular or square periphery while the opening 46 is circular. Further, in some embodiments, the mounting structure may be round while the opening 46 is oval. Further yet, the neck portion 74 may have a peripheral shape that is different than the head portion 72. Due to being able to provide different shaped mounting structures 70, the peripheral shape of the mounting structure 70 need not match the peripheral shape of the filter elements 80, 82. For instance, the mounting structure 70, and particularly head portion 72, may have a round shape while the filter elements 80, 82 have an oval peripheral shape, or visa-versa. The end cap structure 84 also need not match the shape of the head or neck portions 72, 74 of the mounting structure.

In one embodiment, each filter assembly 26 has a longitudinal central axis A-A, and an overall length taken in a direction parallel to the axis A. The length of the filter assembly 26 is greater than the clearance height of the clean air plenum 42 and preferably less than the access height of the dirty air plenum 40 at least in the location closest to the inner periphery of the housing 22. It will be apparent that any number and lengths of filter assemblies 26 could be utilized that are suitable to the filtering requirements of the baghouse 20.

The length of the filter assembly 26 can be any desired length that is appropriate for particular filtering requirements. In one example, at least one of the first and second filter elements 80, 82 of the filter assembly 26 has a length in the range of one meter to three meters. Preferably, the length of the filter element 80 or 82 is less than the clearance height in the access space of the clean air plenum 42. It will also be apparent that the length of the first filter element 80 can be different from the length of the second filter element 82. However, it is preferred that the lengths are identical and the filter elements 80, 82 are identical such that only a single type of filter element need be provided.

The mounting structure 70, filter elements 80, 82 and universal end cap structure 84 are all operably connected to form the filter assembly 26. More particularly, with additional reference to FIGS. 3-5, each one of the mounting structure 70, filter elements 80, 82 and the universal end cap structure 84 includes a coupling portion configured to operably mate the plurality of components into a single unit.

In the illustrated embodiment, the mounting structure 70 includes a coupling portion 86 of a first type. The coupling portion 86 is illustrated in a schematic form as a cavity or as a female coupling portion.

Each filter element 80, 82 includes first and second coupling portions 88, 90. The first coupling portion 88 is of the same type as the coupling portion 86 of the mounting structure 70. The second coupling portion 90 is of a second type that is configured to mate with the coupling portions of the first type, namely coupling portion 86 of the mounting structure 70 and the first coupling portions 88 of other ones of the filter elements. In the illustrated embodiment, the second coupling portion 90 is a male coupling portion illustrated as a projection configured to mate within the female coupling portion provided by coupling portions 86 and 88.

The universal end cap 84 includes a coupling portion 92 of the second type that is similar to the second coupling portion 90. Coupling portion 92 is similarly a male coupling portion configured to mate with the female coupling portions 90 of the filter elements 80, 82.

While the coupling portions 86, 88, 90, 92 are illustrated schematically, in more particular embodiments the coupling portions could be provided by threaded couplings, bayonet style connectors, studs and receiver arrangements as illustrated in U.S. Pat. No. 7,927,392, radially flexible fingers and receiving grooves that allow for a snap fit engagement, etc.

Preferably, the connection between a coupling of the first type and a coupling of the second type allows for a removable connection. As such, the mounting structure 70 and universal end cap 84 can be reused when the current filter elements 80, 82 are replaced with new clean filter elements.

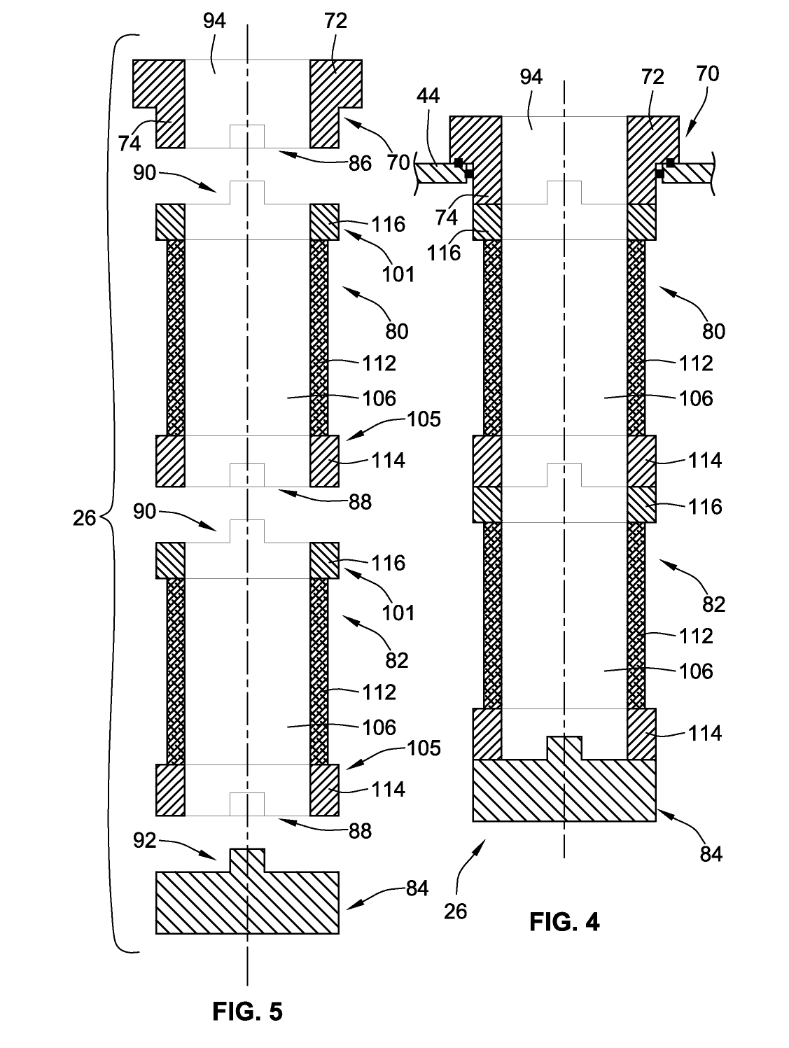

With reference to FIGS. 4 and 5, the mounting structure 70 is a hollow sleeve that defines a hollow flow path 94. Additionally, the filter elements 80, 82 are open at both axial ends 101, 105. As such, when the filter assembly 26 is assembled, the internal cavities 106 of the filter elements and the flow path 94 are fluidly connected to one another such that the internal cavities 106 of the filter elements are communicated with the clean air plenum 42.

When fully assembled, the mounting structure 70 defines an open end of the filter assembly 26 and the universal end cap 84 provides a closed end and closes off the internal cavities 106 to prevent dirty fluid bypass.

The mounting structure 70 and tube sheet 44 define an interface therebetween proximate opening 46. The interface typically provides a sealing connection that prevents dirty fluid bypass and will typically include a seal arrangement provided by one or more gaskets. FIG. 2 illustrates radial gasket 108 and axial gasket 110. Other embodiments may include only one of the gaskets 108, 110. The illustrated gaskets are only schematically shown. However, other sealing interfaces could be used, such as that illustrated in U.S. Pat. No. 7,927,392 or U.S. Pat. No. 5,746,792.

To further prevent fluid bypass, a gasket may be provided between couplings formed between adjacent interconnected portions. For instance, gaskets 111 are illustrated in FIG. 3. These gaskets 111 are axially compressed between the corresponding coupling portions. In other configurations, a radially directed gasket could be provided by adjacent coupling portions, such as if either one of the coupling types was designed to have a portion that is axially received by a corresponding recess in the other one of the coupling types.

Each filter element 80, 82 includes an extension of filter media 112. In the illustrated embodiment, the filter media 112 is an annular tube of filter media having a circular cross-section. In one embodiment, the filter media is provided by a tube of pleated filter media. In other embodiments, other types of media may be used such as molded media. First and second end caps 114, 116 are attached to the filter media 112 proximate opposite ends. The first and second end caps 114, 116 could be attached to the filter media 112 using adhesive (e.g. potting), attached by having the filter media 112 embedded into a surface of the end caps 114, 116, ultrasonically welded to the filter media 112, or other means for securing the end caps 114, 116 to the filter media 112. The end caps 114, 116 are annular members and have central openings that allow for the fluid communication between internal cavities 106 of interconnected filter elements and the flow path 94 of the mounting structure 70.

In the illustrated embodiment, the coupling portions 88, 90 are formed as part of the end caps 114, 116. More particularly, in the embodiment of FIGS. 2-5, the coupling portions 88, 90 are formed as one piece with the remainder of the end caps 114, 116.

Due to the features of the present embodiment, the length L (see FIGS. 1 and 2) of the filtration portion of the filter assembly 26 can be modified by adding additional filter elements 80, 82 to the filter assembly. Further, due to the variations in baghouse sizes and configurations, a maintenance person can carry a single type and size of filter element and construct the various filter assemblies by either adding or subtracting the number of filter elements 80, 82 that are interconnected to form filter assembly 26.

Additionally, if the clean air plenum 42 is much smaller than the dirt air plenum 40, and particular from the roof of the clean air plenum 42 to the tube sheet 44, the filter assembly 26 can be installed separate filter elements 80, 82 and this configuration does not require an excess or wasted volume for the clean air plenum 42. Additionally, even if the roof of the clean air plenum 42 is removable, the surrounding environment can be more compact.

Because the length L of the filter assembly 26 may be very long and in some installations a larger number of filter elements 80, 82 may need to be interconnected to form the filter assembly 26, in some embodiments, the connection between the filter elements 80, 82 provided by the coupling portions 88, 90 may be supplemented by an adhesive or other permanent type of a connection. This can be done to provide more rigidity to the filter assembly 26. However, it is noted that the filter assembly 26 would still be formed from a plurality of separate filter elements 80, 82 interconnected as described above.

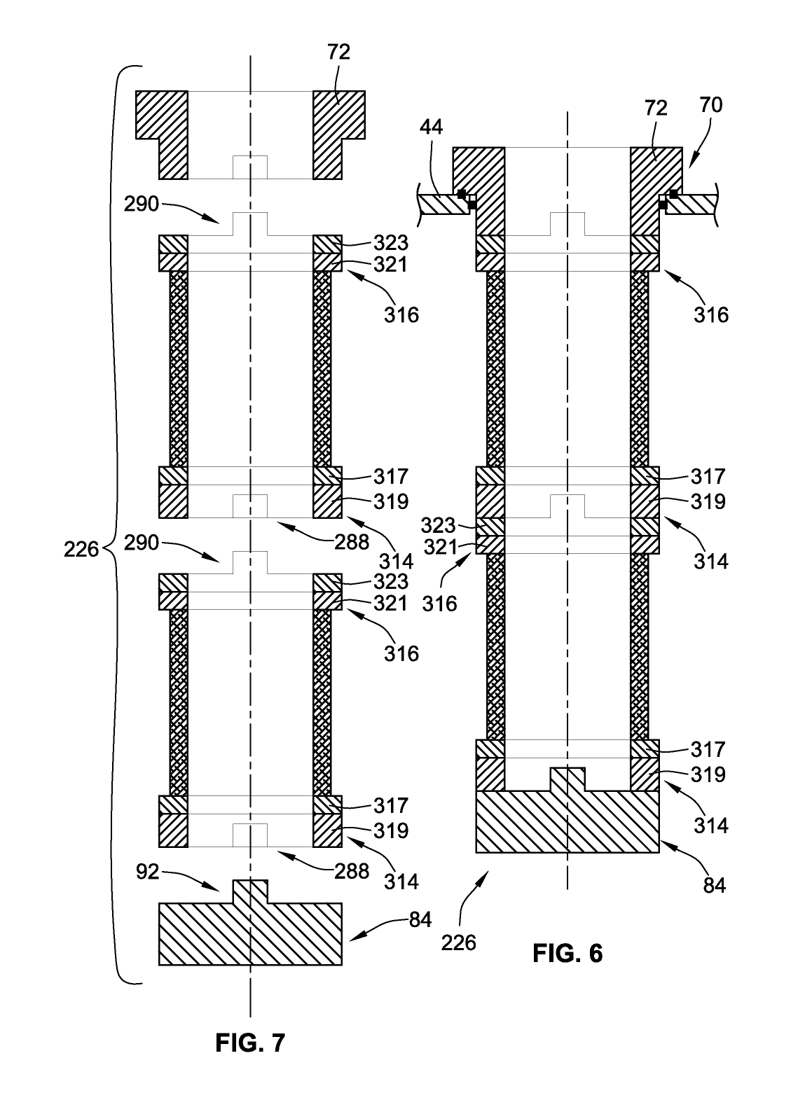

In other embodiments, such as in FIGS. 6 and 7, the coupling portions 1 may be separately formed and then attached to the remainder of the component of the filter assembly 226. For example, the end caps 314, 316 of the embodiment in FIGS. 6 and 7 are formed from a plurality of components that are interconnected.

The end cap 314 in this embodiment includes a primary end cap member 317 and a coupling member 319 attached to the end cap member 317 to form an assembly of components. The primary end cap member 317 is attached to the filter media in a similar manner as the end caps 114, 116 of the prior embodiment. However, in this embodiment, the coupling member 319 is formed as a separate component that is then attached to end cap member 317. The coupling member includes the coupling portion 288.

The connection between the coupling member 319 and the end cap member 317 connection may be by way of a releasable mechanical connection such as by a snap connection. This connection could be by way of a threaded connection. Further yet, the connection could be by way of permanent connection such as ultrasonic welding. An adhesive could be used. As such, it is contemplated that the end cap 314 could be formed from a plurality of components connected together.

The same principle applies to end cap 316 which is formed from end cap member 321 and coupling member 323 which provides coupling portion 290.

Another feature of embodiments of the invention is that it can be simpler to maintain inventory of filter elements for maintenance purposes when different bag houses have different dimensions or configurations of the opening 46 in the tube sheet 44. In such a configuration, a constant supply of filter elements 80, 82 having standard coupling portions of the first and second type can be provided. The only component that would need to be modified is the particular mounting structure 70 that is used to connect the resulting filter assembly 26 to a tube sheet 44.

Various different mounting structures 70 could be provided. The different mounting structures 70 would have differing tube sheet interface structures that have different configurations for mounting with different tube sheet configurations. Typically the different configuration will be a different dimension D1 or a different shape for head portion 72 and/or neck portion 74. For instance, if different tube sheets 44 provide different sized openings 46, different sized mounting structures 70 having different dimensions D1 could be provided. However, all the while the same filter elements 80, 82 could be used for either installation. While the tube sheet interface structure (e.g. head portion 72 or neck portion 74) is different between the different mounting structures 70, the coupling portion 86 thereof would be the same or substantially similar such that the differing mounting structures 70 can connect to the same filter elements 80, 82.

FIG. 9 illustrates a further embodiment of a filter assembly 726. In this embodiment, each filter element 780, 782 includes a center tube 815 that radially supports the filter media 812. The coupling portions 788, 790 of the filter elements 780, 782 of this embodiment are formed as part of the center tubes 815. While shown as being integrally formed as a single piece of material, other embodiments could have the center tubes 815 and coupling portions 788, 790 formed from individual components and then coupled together.

This embodiment further includes end cap members 814, 816 at opposed ends of the filter media 812.

In one embodiment, a method of replacing a filter within a baghouse is provided. The method can include converting from the use of older less flexible filters, such as where the mounting structure is permanently attached to the filter media such that it cannot be reused, to the use of embodiments according to the present invention where the mounting structure and universal end cap can be reused.

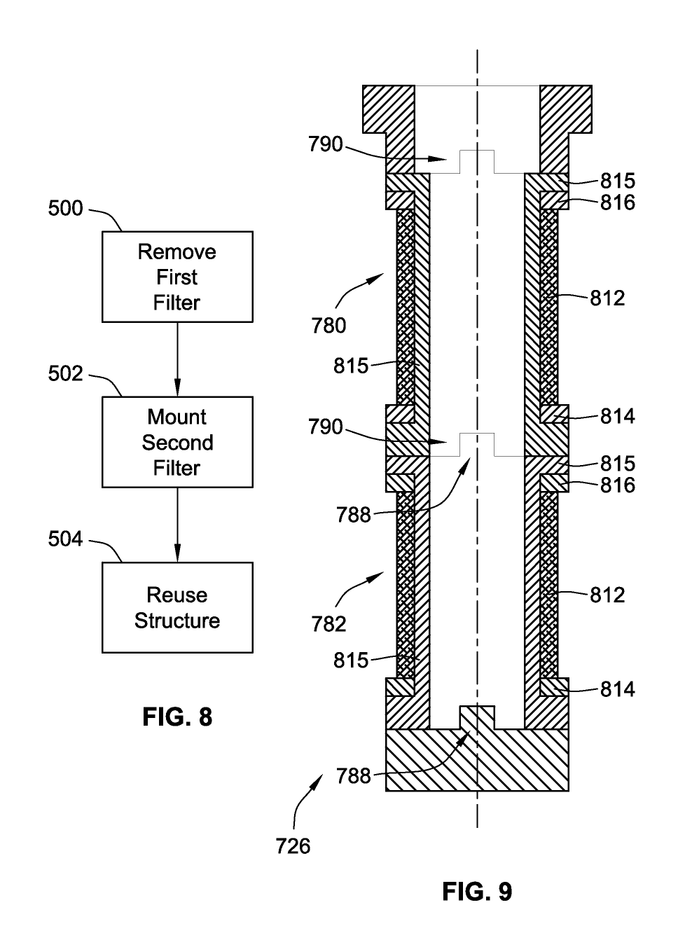

The method, as illustrated in FIG. 8, requires removing a first filter (500). The first filter may have an extension of filter media and a permanent mounting structure attached to filter media.

The method also includes mounting a filter assembly 26 to the tube sheet 44 (502). The filter assembly 26 would be constructed according to embodiments of the invention where the mounting structure 70 would be reusable and would be releasably connected to the filter elements 80, 82 of the filter assembly 26 (504). Further, a universal end cap 84 may also be reused. This would convert the filtration system from using prior style filters to embodiments of the present invention of the modular style.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter assembly for use in a filter system for removing particulate or impurities entrained within a gas stream flowing through the filter system, the filter system having a plurality of plenums separated by a tube sheet, the tube sheet defines an opening through which the gas stream can travel between the plenums, the filter assembly comprising:
a plurality of filter elements, each filter element including:
an extension of filter media;
a first coupling portion attached to the filter media;
a second coupling portion attached to the filter media; the first and second coupling portions being connectable to one another to secure a first one of the plurality of filter elements to a second one of the plurality of filter elements such that fluid communication between the first and second filter elements is established when connected; and
a mounting structure sized and configured to mount to the tube sheet adjacent the opening, the mounting structure including a mounting structure coupling portion being connectable to the first coupling portions.

2. The filter assembly of claim 1, further comprising an end cap structure having an end cap structure coupling portion being connectable to the second coupling portions.

3. The filter assembly of claim 1, wherein the extension of filter media of each filter element is an annular tube of filter media defining an internal cavity, the internal cavities of connected filter elements being in fluid communication.

4. The filter assembly of claim 3, wherein the extension of filter media of each filter element extends axially between first and second ends, the first coupling portion being attached to the filter media proximate the first end and the second coupling portion being attached proximate the filter media proximate the second end.

5. The filter assembly of claim 3, wherein the extension of filter media of each filter element extends axially between first and second ends, the first coupling portion being, at least, part of a first end cap attached to the filter media proximate the first end and the second coupling portion being, at least, part of a second end cap attached to the filter media proximate the second end.

6. The filter assembly of claim 5, wherein the first end cap is an assembly of a plurality of components interconnected together and the second end cap is an assembly of a plurality of components interconnected together.

7. The filter assembly of claim 5, wherein the first end cap is a one piece construction including the first coupling portion and the second end cap is a one piece construction including the second coupling portion.

8. The filter assembly of claim 3, wherein the extension of filter media of each filter element extends axially between first and second ends, each filter element including a first end cap attached to the filter media proximate the first end and a second end cap attached to the filter media proximate the second end.

9. The filter assembly of claim 1, wherein at least one of the filter elements includes a center tube and at least one of the first and second coupling portions of that filter element are attached to the centertube.

10. The filter element of claim 1, further comprising at least one sealing gasket interposed between each interconnected first and second coupling portions.

11. A filter replacement kit for replacing a spent filter element within a filter system, the filter system having a plurality of plenums separated by a tube sheet that defines an opening through which the gas stream can travel between the plenums, the filter replacement kit comprising:
a plurality of filter elements, each filter element including:
an extension of filter media;
a first coupling portion attached to the filter media;
a second coupling portion attached to the filter media; the first and second coupling portions being connectable to one another to secure a first one of the plurality of filter elements to a second one of the plurality of filter elements such that fluid communication between the first and second filter elements is established when connected; and
a first mounting structure including a first mounting structure coupling portion being connectable to the first coupling portions, the first mounting structure including a first tube sheet interface structure having a first configuration configured to mount the first mounting structure to an opening of a tube sheet; and
a second mounting structure including a second mounting structure coupling portion being connectable to the first coupling portions, the second mounting structure including a tube sheet interface structure having a second configuration configured to mount the first mounting structure to an opening of a tube sheet, the second configuration being different than the first configuration.

12. The filter replacement kit of claim 11, wherein the first configuration has a same shape as the second configuration, wherein the first configuration has a different size than the second configuration.

13. The filter replacement kit of claim 11, wherein the first configuration has a different shape than the second configuration.

14. The filter replacement kit of claim 11, wherein the first tube sheet interface structure includes a first sealing surface defining at least in part the first configuration and the second tube sheet interface includes a second sealing surface defining at least in part the second configuration.

15. A method of replacing a spent filter within a filter system, the filter system having a plurality of plenums separated by a tube sheet, the tube sheet defines an opening through which the gas stream can travel between the plenums, the method comprising:
removing a first filter from the tube sheet, the first filter having an extension of filter media and a permanent mounting structure attached to the filter media;
mounting a filter assembly to the tube sheet, the filter assembly including:
a plurality of filter elements, each filter element including:
an extension of filter media;
a first coupling portion attached to the filter media;
a second coupling portion attached to the filter media; the first and second coupling portions being connectable to one another to secure a first one of the plurality of filter elements to a second one of the plurality of filter elements such that fluid communication between the first and second filter elements is established when connected; and
a connectable mounting structure sized and configured to mount to the tube sheet adjacent the opening, the connectable mounting structure including a mounting structure coupling portion being connectable to the first coupling portions.

16. The method of claim 15, wherein the permanent mounting structure includes a first tube sheet interface structure having a first configuration configured to mount the first mounting structure to the opening of the tube sheet, wherein the connectable mounting structure includes a second tube sheet interface structure having a second configuration configured to mount the second mounting structure to the opening of the tube sheet, the first and second interfaces being the same.

17. The method of claim 11, wherein the mounting structure coupling portion releasably and reusably connects to the first coupling portions.

18. The method of claim 17, further comprising the steps of disconnecting the mounting structure coupling portion from a first coupling portion of a spent filter element and connecting the mounting structure coupling portion to a first coupling portion of a replacement filter element.
